(19) United States
(12) Patent Application Publication
(10) Pub. No.: US 2025/0019814 A1
(43) Pub. Date: Jan. 16, 2025

(54) Method of Fabricating Cathode Film Layer of Lithium Ion Battery by Plasma Spraying

(71) Applicant: Institute of Nuclear Energy Research, Atomic Energy Council, Executive Yuan, R.O.C., Taoyuan (TW)

(72) Inventors: Chun-Laing Chang, Taoyuan (TW); Chun-Huang Tsai, Taoyuan (TW); Chang-Shiang Yang, Taipei (TW); Cheng-Yun Fu, Taoyuan (TW); Min-Chuan Wang, Taoyuan (TW); Tien-Hsiang Hsueh, Taoyuan (TW)

(21) Appl. No.: 18/903,110

(22) Filed: Oct. 1, 2024

Related U.S. Application Data
(63) Continuation-in-part of application No. 17/485,620, filed on Sep. 27, 2021.

(51) Int. Cl. C23C 4/134; C23C 4/02; C23C 4/11; H01M 4/02; H01M 4/04; H01M 4/525; H01M 4/62

(52) U.S. Cl. CPC C23C 4/134; C23C 4/02; C23C 4/11; H01M 4/0419; H01M 2004/021; H01M 4/525; H01M 4/625

(57) ABSTRACT

A method is provided for fabricating a cathode film layer of lithium ion batteries through atmospheric plasma spraying (APS) without using polymer adhesive. The ratio of active substance can approach 100%. A cathode film layer fabricated by APS is porous, where, with the coordination of a liquid electrolyte, electrolyte penetration paths are provided to significantly increase the area of reaction. Hence, the effective thickness of the film layer is relatively thick and the capacity of battery is increased. As an example, the thickness of a film layer of lithium cobalt oxide fabricated accordingly reaches more than 100 microns and its maximum electric capacity per unit area reaches 6 milliampere-hours per square centimeter (mAh/cm²).

### TECHNICAL FIELD OF THE INVENTION

Embodiments relate to fabricating a cathode film layer, more particularly, to fabricating a cathode film layer by atmospheric plasma spraying (APS) without polymer adhesive, where a cathode film layer fabricated by APS provides high conductivity and a relatively thick effective thickness, correspondingly increasing the capacity of a battery.

### DESCRIPTION OF THE RELATED ART

Regarding fabrication of a cathode film layer for a lithium ion battery, screen printing is a mainstream technology, where cathode materials are aggregated and adhered onto a surface of a metal substrate by adding a polymer adhesive. The polymer adhesive is an inactive substance that does not undergo electrochemical reaction, such as migrating lithium ions in and out. Accordingly, the capacitance of the cathode is limited. A cathode film layer made through screen printing is affected by the polymer adhesive, as the conductivity of the cathode is limited. After the cathode film reaches an effective thickness, the electric capacity of the lithium battery cannot increase following the increase of the film thickness. This is a limitation of the capacitance of the cathode films currently sold commercially.

Taking the material of lithium cobalt oxide (LiCoO₂) as an example, a respective electric capacity per unit area is about 2-3 milliampere-hours per square centimeter (mAh/cm²) and this cannot be easily further improved. Hence, the prior art does not fulfill all users' requests on actual use.

### SUMMARY OF THE INVENTION

Embodiments provide a method to fabricate a cathode film layer by APS without polymer adhesive, where a content of an active substance can approach 100 percent.

Embodiments provide pores in the cathode film layer, where, with the coordination of a liquid electrolyte, electrolyte penetration paths are provided to significantly increase the effective area of reaction. Resulting effective thickness is relatively thick and the capacity of battery is increased accordingly.

Embodiments provide a method to fabricate a film layer of lithium cobalt oxide by plasma-spraying and with an effective thickness reaching more than 100 μm and a maximum electric capacity per unit area reaching 6 mAh/cm².

To achieve the above purposes, one embodiment is a method of fabricating a cathode film layer of a lithium ion battery by plasma spraying comprising steps of vacuum coating an oxidation-resisting metal layer onto a metal substrate; processing spheroidizing granulation of an active material of lithium, at least one non-lithium metal, and an inactive conductive material to obtain a powder, wherein the powder granules are generally spherical and have a diameter of 10-100 microns (μm); and plasma spraying the powder on the oxidation-resisting metal layer and exposing the powder to a plasma flame to process atmospheric plasma spraying (APS), wherein the APS uses a gas flow of argon and nitrogen uniformly mixed to obtain an atmospheric plasma flame, with a spraying power of 10-50 kilo-watts (KW), the powder is heated to a state selected from a group consisting of a molten state and a semi-molten state; and a porous cathode film layer is thus formed on the oxidation-resisting metal layer of the metal substrate.

### BRIEF DESCRIPTION OF THE DRAWINGS

Embodiments will be better understood from the following detailed description, taken in conjunction with the accompanying drawings, in which

FIG. 1 is a flow view showing an embodiment and

FIG. 2 is a structural view showing a lithium-ion cathode film layer.

### DESCRIPTION OF THE PREFERRED EMBODIMENTS

The following description of preferred embodiments is provided to understand the features and the structures of the present invention.

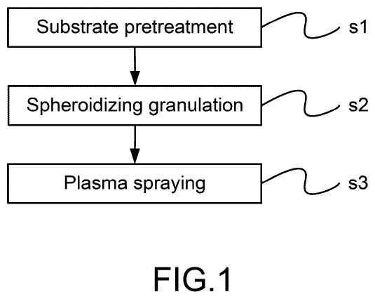

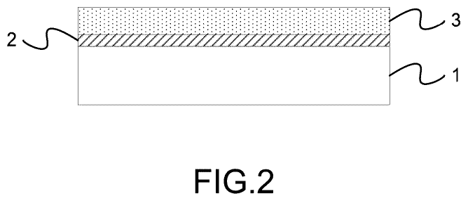

Please refer to FIG. 1 and FIG. 2, which are a flow view showing a preferred embodiment and a structural view showing a lithium-ion cathode film layer, respectively. As shown in the figures, embodiments include a method of fabricating a cathode film layer of a lithium ion battery by plasma spraying comprising the following steps:
(a) Substrate pretreatment s1: A metal substrate 1 is obtained on which to apply vacuum coating, where an oxidation-resisting metal layer 2 is formed on the metal substrate 1.
(b) Spheroidizing granulation s2: Spheroidizing granulation is processed of an active material of lithium, at least one non-lithium metal, and an inactive conductive material to form a powder, where the powder has a generally spherical shape and a diameter of 10-100 microns (μm).
(c) Plasma spraying s3: The powder is put into a plasma flame to process atmospheric plasma spraying (APS) therewith, where the APS uses a gas flow of argon and nitrogen uniformly mixed to generate an atmospheric plasma flame. With a spraying power of 10-50 kilo-watts (KW). The powder is heated to a molten state or a semi-molten state and a porous cathode film layer 3 is thus formed on the oxidation-resisting metal layer 2 of the metal substrate 1.

In one embodiment, the metal substrate 1 is made of iron, chromium, aluminum, or an alloy thereof and has a thickness of 20-400 μm.

In one embodiment, the oxidation-resisting metal layer 2 is made of gold, silver, or platinum.

In one embodiment, the active material is lithium cobalt oxide (LiCoO₂) or lithium nickel cobalt manganese oxide (Li(NiMnCo)O₂).

In one embodiment, the inactive conductive material is graphite or a conductive material.

In one embodiment, a thickness of the porous cathode film layer 3 is greater than 100 μm.

Hence, embodiments have the following features:

A method of fabricating a cathode film layer uses an atmospheric plasma without polymer adhesive. The ratio of active substance can approach 100 percent. Moreover, the cathode film layer fabricated by plasma-spraying is porous, where, with the coordination of a liquid electrolyte, electrolyte penetration paths are provided to significantly increase the area of reaction. Thus, the effective thickness of the film layer is relatively thick and the capacity of a battery is increased accordingly. The thickness of a film layer of lithium cobalt oxide fabricated according to embodiments reaches more than 100 μm a and corresponding maximum electric capacity per unit area reaches 6 milliampere-hours per square centimeter (mAh/cm²). Hence, the performance of an associated solid-state lithium-ion battery is improved and a high-volume manufacturing cost is reduced.

2. Regarding the coating speed, the unique rapid sintering ability of APS is used for fabricating a cathode film layer of a solid-state lithium-ion battery. The coating speed can reach more than 1 μm per minute, where, as compared to the coating speed of 1 nanometer per minute through vacuum coating, rapid production is obtained. Moreover, the oxide film layer fabricated through embodiments can form a correct crystalline structure without heat treatment.

To sum up, embodiments include a method of fabricating a cathode film layer of lithium ion battery by plasma spraying, where a porous cathode film layer fabricated by APS obtains high conductivity and its effective thickness is relatively thick; the capacity of battery is increased accordingly with a maximum electric capacity per unit area reaching 6 milliampere-hours per square centimeter (mAh/cm²); and, thus, the performance of the follow-on solid-state lithium-ion battery is improved with the high-volume manufacturing cost reduced.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating a cathode film layer of a lithium ion battery by plasma spraying comprising steps of:
vacuum coating an oxidation-resisting metal layer onto a metal substrate;
processing spheroidizing granulation of an active material of lithium, at least one non-lithium metal, and an inactive conductive material to obtain a powder, wherein the powder granules are generally spherical and have a diameter of 10-100 microns (μm); and
plasma spraying the powder on the oxidation-resisting metal layer and exposing the powder to a plasma flame to process atmospheric plasma spraying (APS), wherein the APS uses a gas flow of argon and nitrogen uniformly mixed to obtain an atmospheric plasma flame, with a spraying power of 10-50 kilo-watts (KW), the powder is heated to a state selected from a group consisting of a molten state and a semi-molten state; and a porous cathode film layer is thus formed on the oxidation-resisting metal layer of the metal substrate.

2. The method of claim 1, wherein the metal substrate is made of a material selected from a group consisting of iron, chromium, aluminum, and an alloy thereof.

3. The method of claim 1, wherein a thickness of the metal substrate is 20-400 μm.

4. The method of claim 1, wherein the oxidation-resisting metal layer is made of a material selected from a group consisting of gold, silver, and platinum.

5. The method of claim 1, wherein the active material is selected from a group consisting of lithium cobalt oxide (LiCoO₂) and lithium nickel cobalt manganese oxide (Li(NiMnCo)O₂).

6. The method of claim 1, wherein the inactive conductive material is selected from a group consisting of graphite and a conductive material.

7. The method of claim 1, wherein the metal substrate is processed through APS at a heating temperature of 50-500 degrees Celsius (° C.).

8. The method of claim 1, wherein a thickness of the porous cathode film layer is greater than 100 μm.
